(19) United States
(12) Patent Application Publication
(10) Pub. No.: US 2007/0033382 A1
(43) Pub. Date: Feb. 8, 2007

(54) Dynamic configuration of terminals for professional or customer usage

(75) Inventors: Baiju D. Mandalia, Boca Raton, FL (US); Joseph G. Rusnak, Durham, NC (US); Robert J. Sundstrom, Cary, NC (US)

Correspondence Address: CUENOT & FORSYTHE, L.L.C., 12230 FOREST HILL BLVD., STE. 120, WELLINGTON, FL, 33414, US

(73) Assignee: INTERNATIONAL BUSINESS MACHINES CORPORATION, Armonk, NY (US)

(21) Appl. No.: 11/198,418

(22) Filed: Aug. 5, 2005

(51) Int. Cl. G06F 15/00; G06F 15/76

(52) U.S. Cl. 712/23

(57) ABSTRACT

A method of dynamically configuring a terminal within a business establishment can include comparing context information relating to terminal usage within the business establishment with context definitions specifying at least one of time-based rules or terminal usage patterns and selecting a profile according to the comparing step. The profile can specify at least one attribute of a computing resource to be made available within the terminal. The selected profile can be implemented within the terminal.

### BACKGROUND

1. Field of the Invention

The present invention relates to pervasive computing and, more particularly, to dynamically configuring terminals within a business establishment for different types of usage.

2. Description of the Related Art

Many business organizations provide computing terminals to employees for use in performing various business tasks. Typically, these terminals have a set of static computing resources. For example, an employee terminal usually is equipped with a set of applications, network connectivity, and the like. Employee terminals also are provided with a level of system access that surpasses the level of access provided to other guest and/or non-employee users.

The attributes of an employee terminal can differ substantially from the attributes of a customer kiosk or terminal. A terminal that is made available to customers by a business organization typically limits customer access to systems, provides a single application through which the customer interacts with one or more back-end systems, and provides limited communication capabilities. Still, both the customer terminal and the employee terminal are static with respect to the computing resources that are provided.

Because the functions of customer and employee terminals tend to be somewhat exclusive of one another, business organizations are forced to provide both varieties of physical computing machines. For smaller businesses, however, purchasing dedicated employee terminals and dedicated customer terminals can be costly. Further, when purchasing terminals, the business organization must purchase a sufficient number of machines to accommodate those times of the day in which the highest volume of customers is expected. This can lead to situations in which the majority of the time, when customer traffic is considerably lower than peak, one or more customer terminals and/or employee terminals goes unused.

It would be beneficial to provide a system which can accommodate the changing needs of a business, in terms of computing resources, as customer volume changes.

### SUMMARY OF THE INVENTION

The present invention provides a solution for configuring a terminal and/or kiosk within a business organization for various types of usage. One embodiment of the present invention can include a method of dynamically configuring a terminal within a business establishment. The method can include comparing context information relating to terminal usage within the business establishment with context definitions specifying at least one of time-based rules or terminal usage patterns. A profile can be selected according to the comparing step. The profile can specify one or more attributes of a computing resource to be made available within the terminal. The method also can include implementing the selected profile within the terminal.

Another embodiment of the present invention can include a system for dynamically configuring a terminal within a business establishment. The system can include a terminal including at least one computing resource that is dynamically configured. The system further can include an intelligent notification system which collects context information relating to usage of the terminal and dynamic branch logic which interprets the context information and selectively configures the at least one computing resource of the terminal.

Yet another embodiment of the present invention can include a machine readable storage, having stored thereon a computer program having a plurality of code sections executable by a machine. The code sections can cause the machine to perform the steps of comparing context information relating to terminal usage within the business establishment with context definitions specifying at least one of time-based rules or terminal usage patterns. At least one computing resource within the terminal can be dynamically configured according to the comparing step.

### BRIEF DESCRIPTION OF THE DRAWINGS

There are shown in the drawings, embodiments which are presently preferred; it being understood, however, that the invention is not limited to the precise arrangements and instrumentalities shown.

FIG. 1 is a block diagram illustrating a system for configuring computing terminals for different types of usage in accordance with one embodiment of the present invention.

FIG. 2 is a flow chart illustrating a method of configuring computing terminals for different types of usage in accordance with another embodiment of the present invention.

### DETAILED DESCRIPTION OF THE INVENTION

The present invention provides a solution for configuring computing terminals within a business organization. In accordance with the present invention, terminals can be dynamically configured for use by customers and/or employees of an organization based upon demand. Context information relating to terminal usage within an organization can be evaluated. Based upon available context information, one or more terminals can be selectively and dynamically configured for a particular type of usage. For example, an employee terminal having a particular set of computing resources can be configured as a customer terminal having a different and more limited set of computing resources.

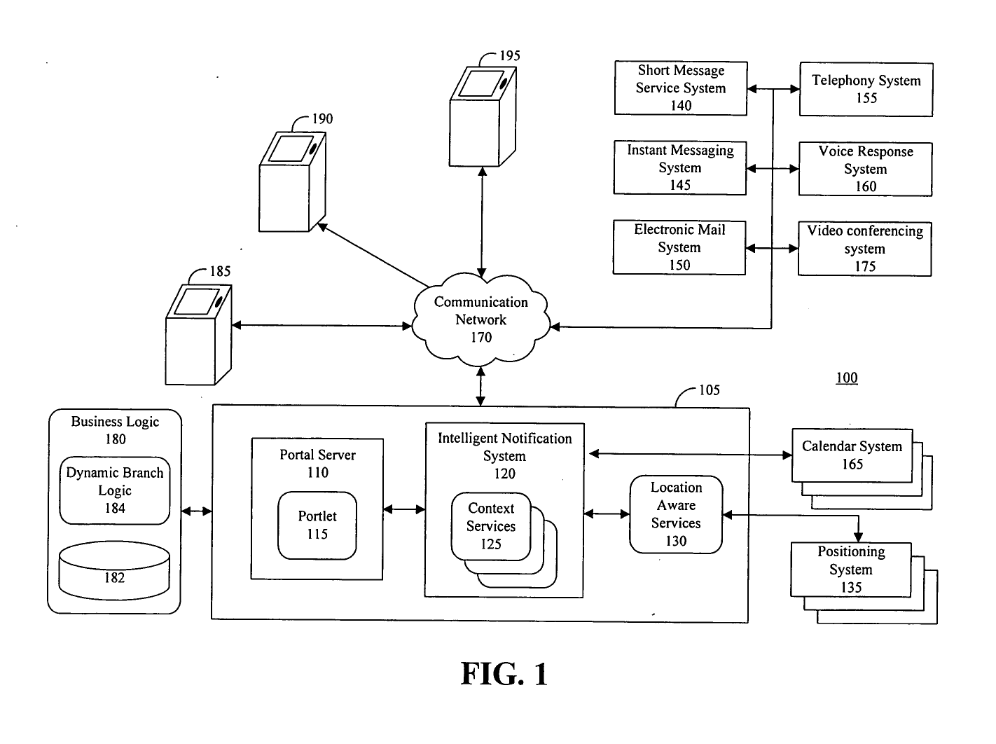

FIG. 1 is a block diagram illustrating a system 100 for configuring computing terminals for different types of usage in accordance with one embodiment of the present invention. The system 100 can include an on-demand computing environment (computing environment) 105 for providing applications to mobile users. Computing environment 105 can be configured as a middleware platform that provides an integrated client-server environment and application development tools to extend business applications and data to mobile devices. Computing environment 105 provides the back-end integration framework necessary for providing functions including, but not limited to, mobile personal information management, electronic mail synchronization, and access to World Wide Web (Web) based and other content.

In one embodiment, computing environment 105 can be implemented as WebSphere® Everyplace Access, which is commercially available from International Business Machines Corporation of Armonk, N.Y. (IBM). WebSphere® Everyplace Access is described in greater detail in the following publications, which are incorporated herein by reference: IBM WebSphere Everyplace Access V5 Handbook for Developers and Administrators, Volume IV: Advanced Topics, IBM (March 2005); IBM WebSphere Everyplace Access V5 Handbook for Developers and Administrators, Volume II: Application Development, IBM (March 2005); and Adding Voice to your Portlet Applications, IBM (July 2004). In any case, the use of a particular computing environment 105 is not intended to limit the scope of the present invention.

The computing environment 105 can include a portal server 110, an intelligent notification system (INS) 120, and location aware services 130. The portal server 110 provides a simple, unified access point through which a variety of functions can be accessed. Although the term “portal” can be used in reference to Web-based applications, this need not be the case. The portal server 110 can be implemented as an application that provides content and/or functionality aggregation regardless of whether the Web or markup language(s) are used. For example, in one embodiment, the portal server 110 can be implemented as WebSphere® Portal, which is available from IBM.

The portal server 110 can include one or more portlets 115. Each portlet 115 can serve as a reusable software component which can execute within the portal server 110. Each portlet 115 can be considered a complete application which can follow a standard model-view-controller design. Further, each portlet 115 can have multiple states and view modes, as well as event and messaging capabilities. Portlets 115 can be accessed visually, via a graphical user interface, or by voice.

In illustration, one portlet 115 can provide a function such as document searching, another can provide user login and/or security, and another can serve as an electronic mail client. With respect to the present invention, a portlet 115 can be provided which allows users to access their profiles to configure communication and message routing options of the INS 120 to be described herein in greater detail. In another embodiment, portlets 115 can be programmed to obtain context information from the INS 120 and compute and/or provide employee availability information based upon that context information.

In general, the INS 120 collects context information from any of a plurality of different sources. This allows enterprises to send messages to mobile users to improve information flow and business efficiency. Context services 125 are disposed within the INS 120. The context services 125 can acquire and analyze context information relating to the usage of terminals 185, 190, and 195 as well as the availability of users. The context information can be made available to the INS 120 and other components of system 100 that may have a need to use such information.

As used herein, context information can include, but is not limited to, information relating to one or more individuals and/or computing systems as may be acquired from any combination of location aware services 130, a calendar system 165, positioning systems 135, and presence-providing systems such as instant messaging (IM) system 145 and/or a telephony system 155, which can be implemented as an Internet Protocol (IP) telephony system. Context information also can be provided from Short Message Service (SMS) system 140, which can be implemented as a Wireless Application Protocol (WAP) based system, electronic mail system 150, and video conferencing system 175. With respect to the messaging systems 140-155 and 175, for example, the context services 125 can be configured to communicate with presence servers through appropriate communication protocols such as SIP for Instant Messaging and Presence Leveraging Extensions (SIMPLE) for communication with an IM system 145 presence server, Parlay for communicating with a telephony system 155 presence server, and the like.

It should be appreciated that the listing of systems from which context information can be derived is not intended to be exhaustive. As such, the list serves only as an example of some of the different types of systems that can be used in conjunction with the INS 120 and from which context information can be obtained for purposes of determining availability of an individual and/or terminal usage.

For example, other means of determining context information can include, but are not limited to, providing a network-connected application that users can use to manually toggle availability from available to not available similar to IM system 145. Agents can be used to detect activity on terminals 185-195 and the type of activity that is taking place, such as the particular application being used, whether a Web conference is ongoing, and the like. Motion and/or sound detectors also can provide context information in terms of individual users and/or customer traffic. Other examples of context information and applications thereof can be found within J. Fogarty and S. Hudson, Examining the Robustness of Sensor-Based Statistical Models of Human Interruptibility, CHI 2004, Apr. 24-29, 2004, Vienna, Austria, which is incorporated herein by reference.

In any case, the INS 120 can interact with different messaging systems such as SMS system 140, IM system 145, electronic mail system 150, telephony system 155, voice response system 160, and video conferencing system 175. The INS 120 can instruct the various messaging systems to send messages, interpret user response data received from the messaging systems, as well as implement the communications capabilities between these systems and the location aware services 130.

For example, a context service 125 can be provided which polls the IM system 145 to determine whether a particular user is logged onto the IM system 145. The context service 125 further can be tasked with communicating with the IM system 145 to command the IM system 145 to send a communication, i.e. an instant message, as well as interpret data received from the IM system 145 such as user responses. In another example, a context service 125 can be provided which can query the calendar system 165 to obtain the schedule of a user, or representative.

In yet another example, the INS 120 can interact with the voice response system 160 and instruct it to perform various functions. Voice response system 160 can perform functions such as placing telephone calls via telephone system 155 and conducting dialogs with a call recipient. Accordingly, the voice response system 160 can provide functions including, but not limited to, executing applications such as Voice Extensible Markup Language (VoiceXML) applications, playing recorded prompts, prompting users through text-to-speech technology, speech recognizing user spoken utterances, and recognizing dual tone multi-frequency (DTMF) input. These capabilities can be used to supply interactive voice response functions for telephone calls conducted over telephony system 155.

In one embodiment, the voice response system 160 can be implemented as, or include, WebSphere® Voice Response, WebSphere® Voice Application Access, and WebSphere® Voice Server, each being available from IBM. WebSphere® Voice response provides telephony connectivity to WebSphere® voice applications, which can be executed therein. WebSphere® Voice Server provides text-to-speech functionality and automatic speech recognition functions. WebSphere® Voice Application Access provides rendering of voice to WebSphere® Portal applications such as portlets 115.

Users can subscribe to services set up by a system administrator, and receive timely, personalized alerts through the INS 120. The INS 120 allows users to subscribe to events and to specify an action to be taken when a match is found between a subscription and an event that is passed to the INS 120. For example, the communication capabilities of the INS 120 can be used to notify a user of the occurrence of an event. As noted, particular messaging attributes and/or routing attributes can be configured by users or employees via an appropriate portlet 115.

Thus, the INS 120 and/or the context services 125 can be configured to perform a variety of different functions relating to context information. Other examples of functions which can be performed by the INS 120 can include collecting, maintaining, and disseminating context information as disclosed in U.S. Patent Publication No. 2003/0018692 entitled “Method and Apparatus for Providing a Flexible and Scalable Context Service”; providing context-aware unified communication for enabling communications between users over a common communications platform or heterogeneous communication platforms as disclosed in U.S. Patent Publication No. 2004/0203664 entitled “System and Method for Context-Aware Unified Communications”; as well as fuse context data for use by context aware applications as disclosed by U.S. Patent Publication No. 2004/0111397 entitled “Method and Apparatus for Fusing Context Data”. Each of these patent publications is incorporated herein by reference.

Location aware services 130 provide a framework for integrating real time location information into communications and business applications. In one embodiment, the location aware services 130 provide the functionality and/or interfaces necessary for interacting with various positioning systems 135. Each location aware service 130 can be tasked with communicating with a particular positioning system 135. The positioning systems 135 can include, but are not limited to, short range wireless location tracking systems such as those based upon one of the 802.11 wireless communication protocols, Global Positioning Systems, and the like. In any case, the location aware services 130 can communicate with the various positioning systems 135 to determine whether a particular user, or more particularly mobile user device, is locatable, and if so, the location for that device and corresponding user.

Location aware services 130 also can be organized at a higher level. For example, the location aware services 130 can include services such as geocoding in reference to determining geographical coordinates for an address received as input, reverse geocoding, directory services where points of interest are located proximate to a given location, routing in reference to determining physical directions from one location to another, mapping which provides a map of a designated location, and device positioning which returns a location of a user's device.

Communication network 170 can include the Internet, the Web, Local Area Networks, Wide Area Networks, the Public Switched Telephone Network, wireless networks whether mobile and/or cellular networks as well as shorter-range wireless networks such as 802.11 type networks, Bluetooth type networks, and the like. It should be appreciated that the particular network architecture used is not intended as a limitation of the present invention.

Business logic 180 can be implemented as a collection of one or more software applications which implement various business processes and/or functions. Data required by the business logic 180 can be stored within data store 182, for example within a database or other suitable data structure. It should be appreciated, however, that data also can be obtained from, or maintained by, an outside data source. In any case, the various capabilities described herein with respect to presence detection, messaging, and calendaring can be accessed by the business logic 180 via the INS 120 and/or portal server 110. Further, information stored within the business logic 180 and/or data store 182, such as customer and/or user (representative) profiles, can be accessed by the portal server 110.

In one embodiment, the business logic 180 can include dynamic branch logic 184. The dynamic branch logic 184 can regulate which computing resources of terminals 185-195 will be available to users of those systems at any given time. In one embodiment, the availability of particular computing resources can be made available on a resource by resource basis. In another embodiment, computing resources can be specified by a profile which is selected by the dynamic branch logic 184 and then implemented in one or more of the terminals 185-195. In any case, the particular profile and/or computing resources selected can be implemented on a per terminal basis. That is, each computing system can be configured independently of the others. It should be appreciated that in addition to selecting resources, the computing resources further can be configured using one or more attributes as may be specified by the selected profile.

Table 1 below illustrates one embodiment of the present invention where different profiles are specified for the terminals 185-195. The available profiles include attended services, unattended services, online services, and remote advisors. Each profile specifies available computing resources, attributes of the resources, and/or access rights which are instituted when that profile is implemented within a given terminal.

TABLE 1

| | Attended | Unattended | Online | Remote |
|---|---|---|---|---|
| | Services | Services | Services | Advisors |
| IP Telephony | Authen- | Anonymous | Anonymous | Authen- |
| | ticated | | | ticated |
| Instant | Authen- | Anonymous | Anonymous | Authen- |
| Messaging | ticated | | | ticated |
| Client | | | | |
| Dynamic | Switched | IEEE 802.11 | Broadband/ | Broadband/ |
| Network | Ethernet | | DSL | DSL |
| Applications | Full | Limited for | Limited for | Full |
| Enablement | | self help | self help | |
| Security | Secure | Secure | VPN | VPN |
| | Intranet | Intranet | | |

For example, a remote advisor, which is a type of employee, is provided with full application rights and the security mechanism used is a virtual private network (VPN). The profile for the remote advisor further configures the terminal for using a broadband network connection. Online services, which can be accessed by customers, provide more limited or restricted computing resources.

Terminals 185-195 can be implemented as information processing systems which can be configured for use by customers and/or employees. In general, when configured for use by an employee, a terminal can be said to provide a larger, or more comprehensive, set of computing resources. By comparison, a terminal configured for use by a customer typically provides limited access to computing resources, different computing resources, or both limited access and a different set of computing resources. Thus, the terminals 185-195 can include various computing resources, such as those described in Table 1, which can be dynamically configured. As used herein, configuring a computing resource can include assigning values to one or more parameters of the computing resource as well as selectively enabling the computing resource.

In any case, the terminals 185-195 can include input and output devices for providing access to various communication channels. Each of terminals 185-195 can include audio input and output devices, video input and output devices, a keyboard, whether physical or virtual, as well as a pointing device such as a mouse, stylus, and/or touch screen. The terminals 185-195 further can include and execute one or more programs, whether business applications or communication programs, to provide functions such as instant messaging (IM), telephony services, wireless communications, electronic mail, videoconferencing, and the like.

In operation, the INS 120, using the various context services 125, can collect various types of context information relating to usage of terminals 185-195. This context information can include, but is not limited to, the time of day, date, and/or day of the week, which may be obtained from the calendar system 165, the types of applications and/or computing activity that has been detected or executed on a particular terminal as determined from one or more agents executing within the terminal(s), as well as other physical indicators of customer traffic that may be determined from other sensing systems described herein.

The dynamic branch logic 184 can access the context information and interpret the context information based upon various rules. For example, the dynamic branch logic 184 can compare context information relating to terminal usage within the business establishment with one or more context definitions. The context definitions, i.e. rules, can specify one or more time-based rules or terminal usage patterns. Profiles and/or resources can be associated with context definitions. Accordingly, the dynamic branch logic 184 can select a particular profile and/or particular computing resources to implement or configure within one or more of the terminals 185-195 based upon which context definition matches the context information. For example, in one embodiment, at a particular time of day, a terminal can be dynamically configured to function as a customer terminal. Later on in the day, the terminal can be dynamically configured again to function as an employee terminal.

In another embodiment, transformations between customer and employee terminals can be based upon a determination of the level of customer traffic in a branch, i.e. usage patterns. That is, if a high level of customer traffic is detected, for example from sound and/or motion sensors, then more terminals can be dynamically configured as customer terminals. In yet another embodiment, dynamic configurations can be based upon another usage pattern such as the level of activity and type of activity detected on a terminal. For example, if a terminal configured for use as an employee terminal is experiencing a low level of activity, while other terminals configured as customer terminals are experiencing a high level of activity, the employee terminal can be dynamically configured to function as a customer terminal.

The examples of processing context information relating to terminal usage have been provided for purposes of illustration only. As such, the examples are not intended to limit the scope of the present invention. It should be appreciated that other rules can be implemented for interpreting any of a variety of context information discussed herein. Further, various rules can be combined and/or weighted such that different types of context information can be evaluated concurrently to determine whether a given terminal should be dynamically configured for a particular use.

Further, though dynamic terminal configuration has been described with reference to computing resources such as network connections, communications, application availability and the like, it also should be appreciated that physical characteristics of a terminal can be modified in accordance with the profile that is selected. For example, if a customer profile is implemented, the profile can specify that a clear tamper-proof cover is to automatically extend across the monitor screen to protect the display. The physical location of the terminal also can be changed in accordance with the profile that is loaded. The terminal can be attached to a mechanical apparatus for moving the terminal automatically. Thus, when the terminal is to be used by customers, the terminal can be automatically located in a particular position and the display cover can extend down automatically. When configured for use by employees, the physical location of the terminal can be automatically changed and the display cover can be automatically lifted.

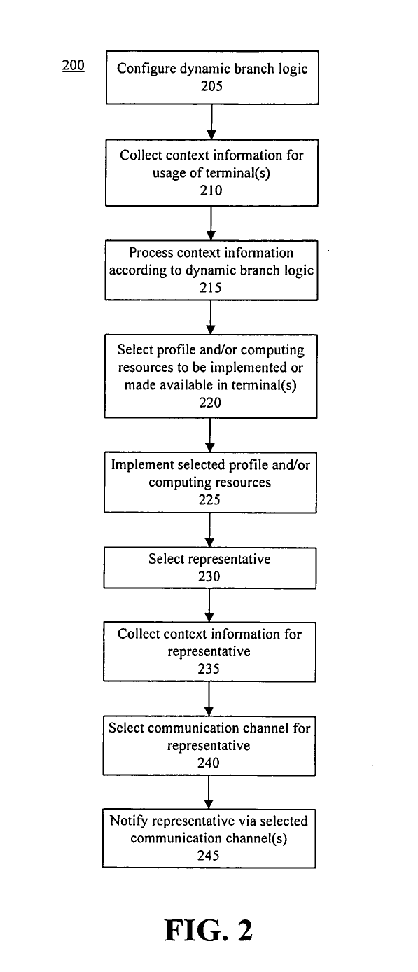

FIG. 2 is a flow chart illustrating a method 200 of configuring terminals for different types of usage in accordance with another embodiment of the present invention. In one embodiment, the method 200 can be implemented using the system of FIG. 1. As such, one or more terminals can be provided on premises of an organization. The terminals can be available for use by both customers and employees of the organization. Method 200 can begin in step 205 where the dynamic branch logic is configured to interpret context information relating to terminal usage. As noted, various rules can be established for interpreting context information and selecting a particular profile based upon that interpretation. The profile can specify one or more computing resources that are to be made available from the terminal within which the profile is implemented. As noted, the profile further can specify physical attributes of the terminal which can be changed dynamically.

In step 210, context information relating to the usage of the terminal(s) can be collected via the INS. As noted, context information, as it relates to terminal usage, can include, but is not limited to, which applications are executing within the terminal, the time of day, the date, the day of the week, as well as which functions and/or applications other terminals within the business organization are performing and/or executing.

In step 215, the dynamic branch logic can process the available context information to determine how to configure one or more of the terminals. The rules that were established within the dynamic branch logic can be applied to the context information. For example, one rule may state that if the terminal is configured for use by a customer and goes unused for a minimum time period, while other terminals are being used by employees, the unused customer terminal is to be dynamically configured for use by employees. Other rules can be based upon the time of day, the date, etc. Thus, for example, between the hours of 10:00 a.m. and 2:00 p.m., employee terminals can be dynamically configured for use by employees.

In step 220, based upon the rules within the dynamic branch logic, a profile for one or more of the terminals can be selected. As noted, the profile can specify which computing resources are to be made available or implemented within the terminal. The profile further can specify configuration attributes for the computing resources as well as any access rights corresponding to the computing resources. Thus, a profile corresponding to customer usage of a terminal can have limited computing resources, with restricted configurations, and limited access rights. By comparison, a profile suitable for an employee can specify that an extended set of computing resources, resource configurations, and access rights are to be made available.

It should be appreciated that while employee and customer profiles are discussed herein, additional profiles can be defined as well. Any profile from the set of available profiles can be selected based upon the context information. The profiles can viewed as a continuum where computing resources, access rights, and the like are most restricted on one end of the continuum and are least restricted on the other.

In step 225, the selected profile can be implemented within the terminal. Accordingly, the terminal is reconfigured under the direction of the dynamic configuration logic as specified by the selected profile. Thus, computing resources such as IP telephony, networking, applications, and the like can be selectively enabled and configured according to attributes specified within the profile. Further, access rights can be established within the terminal as set forth in the profile. Physical attributes of the terminal also can be modified in accordance with the selected profile.

In accordance with another aspect of the present invention, method 200 can continue to notify one or more selected representatives, or employees, of the organization regarding different terminal state changes. For example, if a terminal is changed from a customer configuration to an employee configuration, a representative can be notified of the change and that the representative is needed to man the terminal.

Thus, in step 230, a particular representative from a plurality of representatives can be selected. In one embodiment, representative selection can be performed by the business logic by selecting a person that is on-call or by selecting a representative having a particular set of attributes or skills as specified in an employee profile. The representative can be selected to meet with a particular customer, i.e., one using a terminal. The meeting can take place through the terminal in the form of an IM session, a teleconference, a videoconference, or the like. In another embodiment, context information as to the whereabouts of representatives can be used to select a representative. For example, a representative that is near or proximate to the terminal that is to be manned can be selected.

In any case, in step 235, context information for the representative can be collected via the INS and the context services disposed therein. Context information relating to an individual can include, but is not limited to, calendar information such as the time of day, the day of the week, and the date, presence information, location information, and the like. Based upon the context information for the representative, a communication channel such as IP telephony, electronic mail, IM, paging or the like can be selected in step 240.

The selection of one or more communication channels to be used to notify the representative can be made based upon a policy stored within the business logic. The policy can indicate which communication channel(s) are to be selected for sending a message based upon the state and/or type of the context information collected. The policy can state that on a particular day within a particular time period, the representative is to be contacted via mobile phone. Other policies can be more complex and can be used to resolve ambiguities in the context information. For example, when the calendar of the representative indicates that he or she is out of the office and, therefore, should be reached via pager or mobile phone, but the representative has a presence on a communication system, the policy can indicate that presence information takes priority over the calendar information.

In another embodiment, the policy can prioritize and/or assign weights to the different types of context information such as calendar, presence, location, or subsets thereof such as IM presence, telephony presence, and the like. For example, calendar information can be given the highest priority. This allows administrators to establish policies defining a hierarchy of context information importance which can be used to select a particular communication channel.

It should be appreciated that the selection of a particular representative also can be based upon the availability of one or more representatives as determined from the context information. As noted, context information can include calendar information, presence information, location information, as well as other sensor information, which when taken collectively, can indicate the availability of the user as well as which communication channel is most likely to be able to reach the user.

In step 245, a message can be sent to the representative via the selected communication channel(s). The message can be any of a variety of predetermined messages such as “your presence is requested at terminal 1”, “terminal 1 is being reconfigured as a customer terminal, please move to terminal 2”, etc. The message can be text-based as in the case of an SMS message, IM, electronic mail, or audio-based as in the case of a telephone call.

It should be appreciated that although method 200 has largely been described with reference to a single terminal, the inventive arrangements disclosed herein also can be applied to cases where a plurality of terminals are to be dynamically configured. In that case, each terminal can be configured independently of the others. In another embodiment, one or more or all of the terminals can be configured in the same manner.

The present invention can be realized in hardware, software, or a combination of hardware and software. The present invention can be realized in a centralized fashion in one computer system or in a distributed fashion where different elements are spread across several interconnected computer systems. Any kind of computer system or other apparatus adapted for carrying out the methods described herein is suited. A typical combination of hardware and software can be a general-purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program, software application, and/or other variants of these terms, in the present context, mean any expression, in any language, code, or notation, of a set of instructions intended to cause a system having an information processing capability to perform a particular function either directly or after either or both of the following: a) conversion to another language, code, or notation; b) reproduction in a different material form.

This invention can be embodied in other forms without departing from the spirit or essential attributes thereof. Accordingly, reference should be made to the following claims, rather than to the foregoing specification, as indicating the scope of the invention.

What is claimed is:

1. A method of dynamically configuring a terminal within a business establishment comprising:
comparing context information relating to terminal usage within the business establishment with context definitions specifying at least one of time-based rules or terminal usage patterns;
selecting a profile according to said comparing step, wherein the profile specifies at least one attribute of a computing resource to be made available within the terminal; and
implementing the selected profile within the terminal.

2. The method of claim 1, wherein the profile is selected from a plurality of profiles, wherein the plurality of profiles comprises an employee profile and a customer profile.

3. The method of claim 1, wherein the at least one attribute is for configuring an Internet Protocol telephone client executing within the terminal.

4. The method of claim 1, wherein the at least one attribute is for configuring an instant messaging client executing within the terminal.

5. The method of claim 1, wherein the at least one attribute specifies a network connection accessible by the terminal, wherein the network connection is selected from a plurality of different network connections.

6. The method of claim 1, wherein the at least one attribute specifies at least one application from a plurality of applications to be enabled for use on the terminal.

7. The method of claim 1, wherein the at least one attribute specifies a network security mechanism to be used by the terminal.

8. The method of claim 1, further comprising notifying a representative of the business organization of a terminal state change via a communication channel selected from a plurality of communication channels, wherein the communication channel is selected according to context information for the representative.

9. The method of claim 1, said implementing step further comprising automatically changing a physical attribute of the terminal according to the selected profile.

10. A system for dynamically configuring a terminal within a business establishment comprising:
a terminal comprising at least one computing resource that is dynamically configured;
an intelligent notification system collecting context information relating to usage of the terminal; and
dynamic branch logic interpreting the context information and selectively configuring the at least one computing resource of the terminal.

11. The system of claim 10, wherein the dynamic branch logic selectively enables at least one program executing within the terminal.

12. The system of claim 10, wherein the dynamic branch logic configures at least one attribute of a program executing within the terminal.

13. The system of claim 10, wherein the at least one computing resource is a network connection.

14. The system of claim 10, wherein the terminal comprises at least one physical attribute that is automatically configured responsive to an instruction from said dynamic branch logic issued responsive to interpreting the context information.

15. A machine readable storage, having stored thereon a computer program having a plurality of code sections executable by a machine for causing the machine to perform the steps of:
comparing context information relating to terminal usage within the business establishment with context definitions specifying at least one of time-based rules or terminal usage patterns; and
dynamically configuring at least one computing resource within a terminal according to said comparing step.

16. The machine readable storage of claim 15, said dynamically configuring step further comprising adjusting a communication client disposed within the terminal to execute in an anonymous or authenticated mode according to the context information.

17. The machine readable storage of claim 15, said dynamically configuring step further comprising instructing the terminal to access a particular network connection selected from a plurality of network connections.

18. The machine readable storage of claim 15, said dynamically configuring step further comprising activating at least one of a plurality of applications for use on the terminal.

19. The machine readable storage of claim 15, said dynamically configuring step further comprising adjusting the terminal to communicate using a particular security mechanism.

20. The machine readable storage of claim 15, said dynamically configuring step further comprising selecting a profile which specifies the computing resources to be enabled within the terminal.
